(19) United States
(12) Patent Application Publication
(10) Pub. No.: US 2015/0254738 A1
(43) Pub. Date: Sep. 10, 2015

(54) SYSTEMS AND METHODS FOR AERIAL IMAGING AND ANALYSIS

(71) Applicant: TerrAvion, LLC, Livermore, CA (US)

(72) Inventors: Cornell Wright, III, Berkeley, CA (US); Robert Morris, Oakland, CA (US); Amariah Fuller, Concord, CA (US); Angus Tsai, Saratoga, CA (US); Greg Thompson, Livermore, CA (US); Michael Whiting, Davis, CA (US)

(21) Appl. No.: 14/636,993

(22) Filed: Mar. 3, 2015

Related U.S. Application Data
(60) Provisional application No. 61/948,178, filed on Mar. 5, 2014.

(51) Int. Cl. G06Q 30/02; G06T 11/00; G06K 9/00; G06Q 30/06; G06T 7/60

(52) U.S. Cl. CPC G06Q 30/0284; G06Q 30/0635; G06T 7/602; G06K 9/0063; G06T 11/001; G06T 2207/10032; G06T 2207/30188

(57) ABSTRACT

Various of the disclosed embodiments concern aerial imaging platforms, systems and methods for image analysis, flight redirection, and order placement. In some embodiments, orders for aerial imaging and analysis may be placed by an online, browser-based system. A user may define a region, for example, a polygon, on a map reflecting the area to be analyzed. A series of overflights may be performed of the region and consolidated results of an imaging analysis provided to the customer.

### CROSS-REFERENCE TO RELATED APPLICATIONS

This application claims priority to and is a nonprovisional of U.S. Provisional Pat. App. No. 61/948,178 filed on Mar. 5, 2014, the contents of which are incorporated by reference herein in their entirety for all purposes.

### FIELD OF THE INVENTION

Various of the disclosed embodiments concern systems and methods for aerial imaging and analysis of ground-based phenomenon.

### BACKGROUND

There is an increasing need for systematic appraisals of various land conditions. Farmers and foresters, for example, regularly need up-to-date information concerning the health and irrigation of vegetation over different periods of time. City planners must also remain apprised of conditions at various locations in their community. Additionally, fields including real estate construction, insurance, mining, and economic forecasting all require up-to-date, comprehensive information. Accordingly, there exists a need for aerial imaging and analysis of ground-based phenomenon over varying periods of time. Furthermore, there is a need for a simple interface by which users can request overflights of their regions on a dynamic basis, possibly in real-time.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates a partially schematic depiction of the overflight, data-gathering, and analysis processes as can be implemented in some embodiments.

FIG. 2 is an image of the under-carriage of a sensor system as can be implemented in some embodiments.

FIG. 3 is a system-block diagram of a data acquisition system as can be implemented in some embodiments.

FIG. 4 is a generalized variation of the system presented in FIG. 3 as can be implemented in some embodiments.

FIG. 5 is a generalized flow diagram depicting various operations in a data acquisition process as can be implemented in some embodiments.

FIG. 6 is a system-block diagram of a cloud-based data analysis and upload system as can be implemented in some embodiments.

FIG. 7 is a generalized variation of the system presented in FIG. 6 as can be implemented in some embodiments.

FIG. 8 is a flow diagram depicting a processing pipeline as can be implemented in some embodiments.

FIG. 9 is a flow diagram depicting a rerouting algorithm as can be implemented in some embodiments.

FIG. 10 is a screenshot of a selection system for specifying customer orders as can be implemented in some embodiments.

FIG. 11 is a screenshot of a selection system for specifying customer orders following creation of an order block as can be implemented in some embodiments.

FIG. 12 is a screenshot of a checkout display for an order block as can be implemented in some embodiments.

FIG. 13 is a high level depiction of an order block creation as can be implemented in some embodiments.

FIG. 14 is a plurality of screenshots depicting an order block creation as can be implemented in some embodiments.

FIG. 15 is an enlarged view of the order block of FIG. 14.

FIG. 16 is a screenshot of data collected for an ongoing order as can be presented to a user in some embodiments.

FIG. 17 is a series of time-lapse images of data gathered from a field as can be implemented in some embodiments.

FIG. 18 is a screenshot of an example regional selection interface to review an order as can be implemented in some embodiments.

FIG. 19 is a screenshot of the example regional selection interface of FIG. 18 following block selection as can be implemented in some embodiments.

FIG. 20 is a screenshot of the example regional selection interface of FIG. 19 with NDVI viewing for the 8/26 dataset as can be implemented in some embodiments.

FIG. 21 is a screenshot of the example regional selection interface of FIG. 19 with NDVI viewing for the 9/23 dataset as can be implemented in some embodiments.

FIG. 22 is a screenshot of the example regional selection interface of FIG. 19 with CIR viewing for the 9/9 dataset as can be implemented in some embodiments.

FIG. 23 is a screenshot of the example regional selection interface of FIG. 19 with order block selection activated as can be implemented in some embodiments.

FIG. 24 is a screenshot of the example regional selection interface of FIG. 23 with an order block created as can be implemented in some embodiments.

FIG. 25 is a an example system topology applicable to various of the user interface embodiments.

FIG. 26 shows a diagrammatic representation of a machine in the example form of a computer system within which a set of instructions for causing the machine to perform any one or more of the methodologies discussed herein can be executed.

Those skilled in the art will appreciate that the logic and process steps illustrated in the various flow diagrams discussed below may be altered in a variety of ways. For example, the order of the logic may be rearranged, substeps may be performed in parallel, illustrated logic may be omitted, other logic may be included, etc. One will recognize that certain steps may be consolidated into a single step and that actions represented by a single step may be alternatively represented as a collection of substeps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed and/or encrypted; etc.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### System Topology Overview

Various of the disclosed embodiments disclose systems and methods for aerial imaging and analysis of ground-based phenomenon. Particularly, various embodiments provide for high revisit coverage of ground-based features.

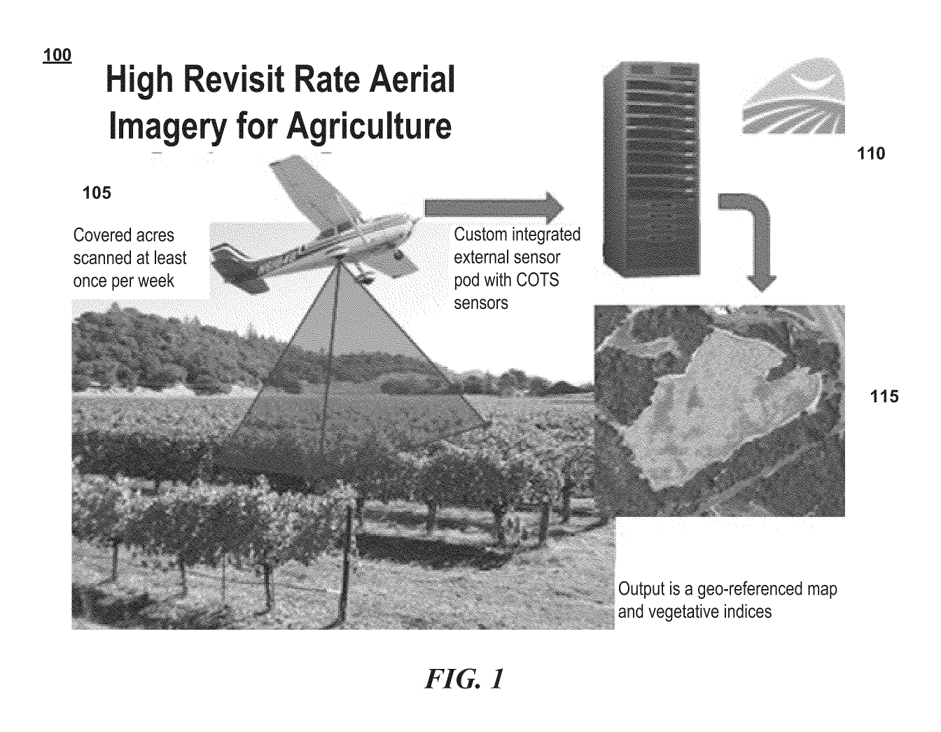

FIG. 1 illustrates an abstract depiction 100 of the overflight, data-gathering, and analysis processes as can be implemented in some embodiments. At block 105, an aerial platform (for example, an airplane, balloon, unmanned air vehicle, etc.) equipped with imaging equipment can image a ground-based target such as an agricultural field. The target can be scanned often, for example, once or twice a week. These overflights can be scheduled in advance, or performed dynamically, in response to user requests from, for example, the Internet, over an aerial network link. The raw image data can be provided to an analysis system at block 110, located either onboard the aerial platform or at a ground-based location. The data can be transmitted immediately following capture or can be retrieved from a storage medium upon the aerial platform's return to a landing field, to a customer, a deployment specialist, etc.

At block 115, the processed data can be used to generate a geo-referenced map. For example, where the target is an agricultural area, vegetative indices can be used to reflect healthy vegetation. By compositing images from successive overflights, a time-lapsed perspective of the vegetation's health (or other feature to be observed) can be generated by the system.

### Sensor System Design

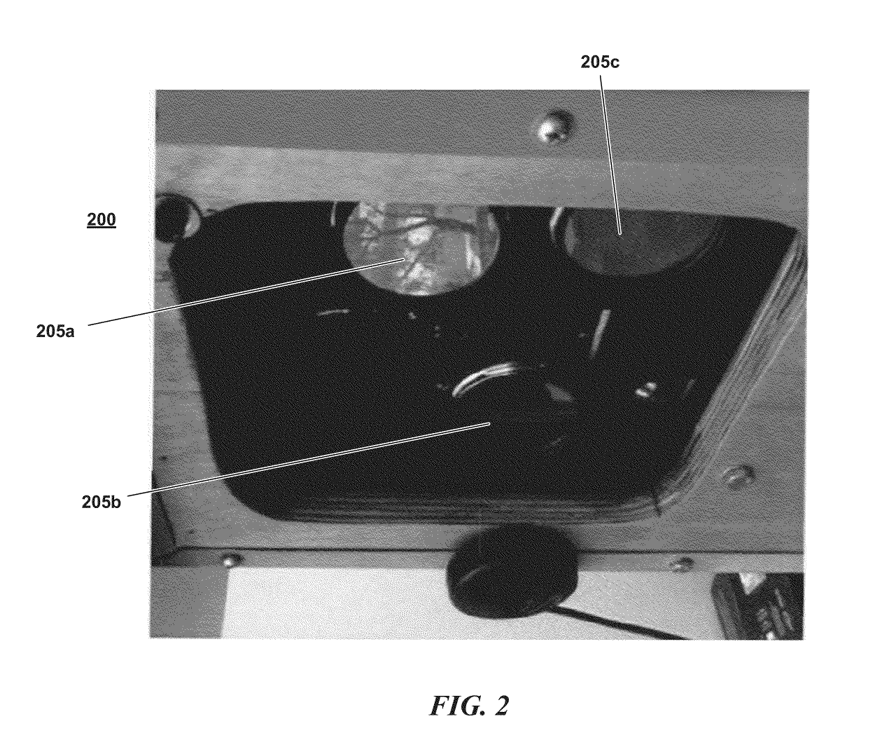

FIG. 2 is an image of the under-carriage 200 of a sensor system as can be implemented in some embodiments. The sensor system can include a plurality of different imaging components. For example, visual range (VIS) sensor component 205b, Near Infrared (NIR) sensor component 205c, and Long Wavelength Infrared (LWIR) component 205a can operate in conjunction with one another to generate complementary image datasets. In some embodiments, vegetation specific cameras, reflectance systems, and/or thermal imaging devices can be mounted on the system. In some embodiments, a cooled CCD camera, such as can be used in astronomical observation, can be repurposed for image capture from the aerial platform for example, to reduce the effect of noise on very short exposures, narrow spectral bands, or low light conditions. Thermal imaging equipment can also be used (for example, infrared imaging). The image systems can be complementary and their respective datasets integrated to provide a comprehensive perspective of the regions being imaged.

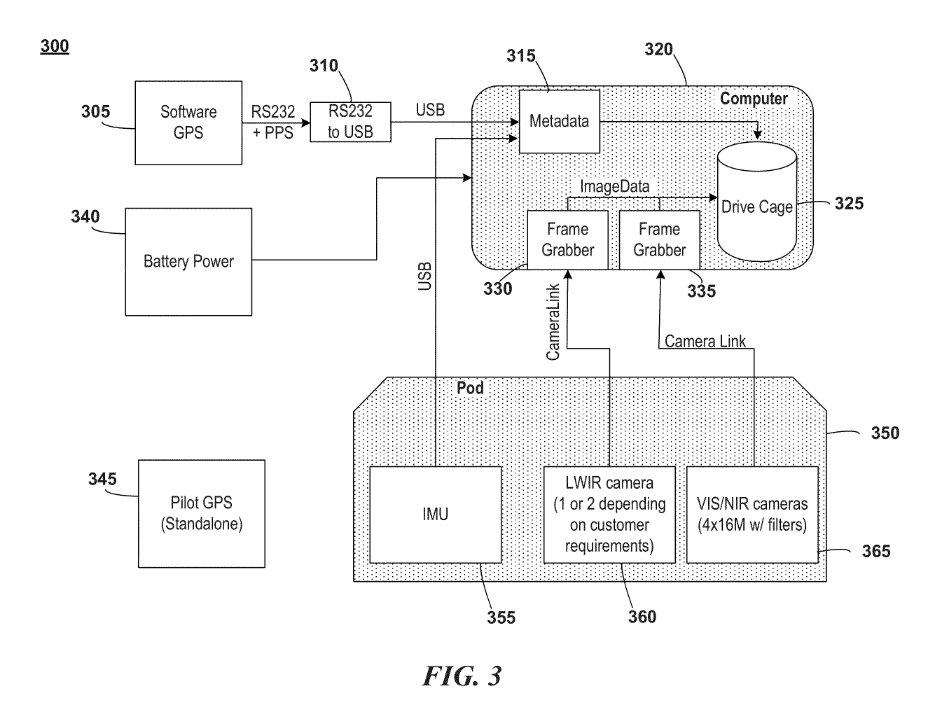

FIG. 3 is a system-block diagram of a data acquisition system 300 as can be implemented in some embodiments. All or part of the system 300 can be located on the aerial platform in some embodiments. An imaging pod 350 can include the sensors for acquiring the raw image data. A battery 340 powers a collection computer 320 which can be used to perform certain aspects of the image processing or simply to collect the data for subsequent analysis. In some embodiments, the computer can be powered directly by the aircraft's alternator or other power source.

A pilot GPS 345 can be present to orient the human or robotic pilot of the aerial platform. In some embodiments the same, or a separate software GPS 305, can be used to create geographic associations for the image data. For example, upon capturing an image, the location can be provided to computer 320 across link 310, along with inertial data from Inertial Measurement Unit (IMU) 355. Some embodiments use an active sensor (or laser) to automatically calibrate, or acquire inertial motion metadata for the images acquired. This data can be used to apply a transformation to the image data (for example, an affine transformation) so that the image data corresponds to previous and/or future overflights of the region. An airborne data-link can also be present to provide real-time updates to the robotic or human pilot. For example, customers can place orders through the Internet and the orders can redirect the aerial platform's flight path accordingly. The flight path redirections can be optimized based upon the platform's current position, existing target list, fuel consumption/availability, etc.

In some embodiments, the onboard system can also include a device (for example, a skyward pointing sensor) that continually tracks the sun and measures downwelling radiation for radiometric corrections. The computer 320 can take these radiation measurements into account when processing the raw image data. The computer 320 can also handle the geographic metadata association for imaging data acquired using pod 350. Long wavelength infrared (LWIR) camera(s) 360 and visible (VIS)/visible near infrared (NIR) cameras 365 can provide imaging information to the computer 320 while IMU 355 can provide gyroscopic and/or accelerometer data to the computer regarding motion of the aerial platform and/or pod 350. The computer 320 can process the image data using the inertial information to remove artifacts caused by the motion or orientation of the platform. Alternatively, the computer 320 can record the inertial data for subsequent use by a ground-based processing system to clean the image data. Frame grabbers 330, 335 can be used to isolate the image frames for storage in a drive cage 325.

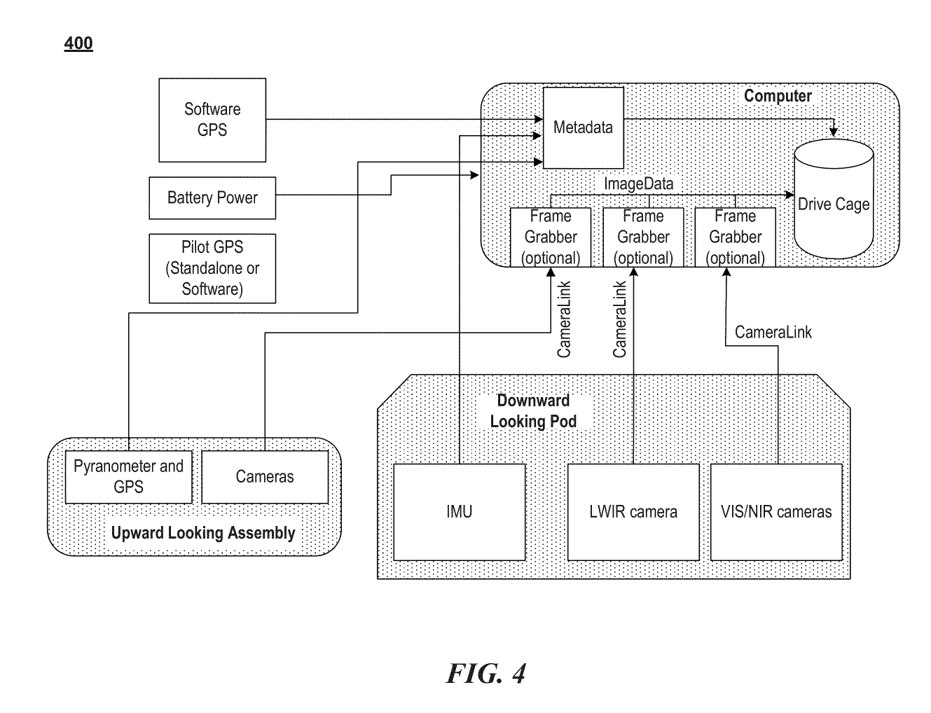

FIG. 4 is a generalized variation 400 of the system presented in FIG. 3 as can be implemented in some embodiments.

### Image Processing and Data Analysis Pipeline

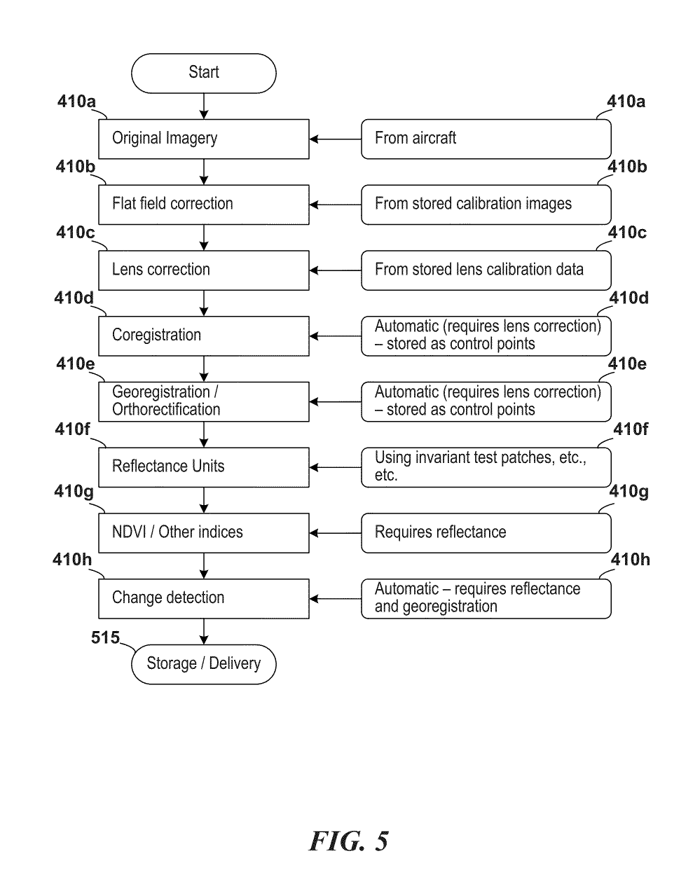

FIG. 5 is a generalized flow diagram depicting various operations in a data acquisition process as can be implemented in some embodiments. Though depicted in a particular order for purposes of explanation, one will recognize that the data can arrive in many different orders and the various operations can be applied at different times. At block 505a raw imagery data can be acquired from the aerial platform 510a. At block 505b a flat field correction can be performed using calibration data from stored images 510b. Calibration data can include, for example, images of known surfaces, such as parking lots or rooftops, with known reflectance and other values (determined, for example, by crowdsourcing requests from the public). Such data can be acquired at the beginning of each flight or at various portions throughout the day. At block 505c a lens correction can be performed, for example, from stored lens calibration data 510c such as can have been acquired by the aerial platform. At block 505d, coregistration operations can be performed and may or may not require lens correction 510d depending upon the apparatus and procedures used. Coregistration can generally involve the alignment of two or more images using inertial data, GPS location data, common reference points in the image, combinations of the above, etc. In some embodiments, georegistration/orthorectification can be applied at block 505e, and can also depend upon lens correction 510e. At block 505f, reflectance units can be determined using invariant test patches 510f or other known techniques. At block 505g, a normalized difference vegetation index (NDVI) can be determined for the image using reflectance units 510g. At block 505h, change detection between two or more frames can be performed, and can employ reflectance and georegistration information 510h. In some embodiments, the system can perform change detection solely with respect to the images being compared (for example, identifying groups of varying pixels). The data and/or results of the analysis can then be stored for subsequent analysis or delivered to the customer 515.

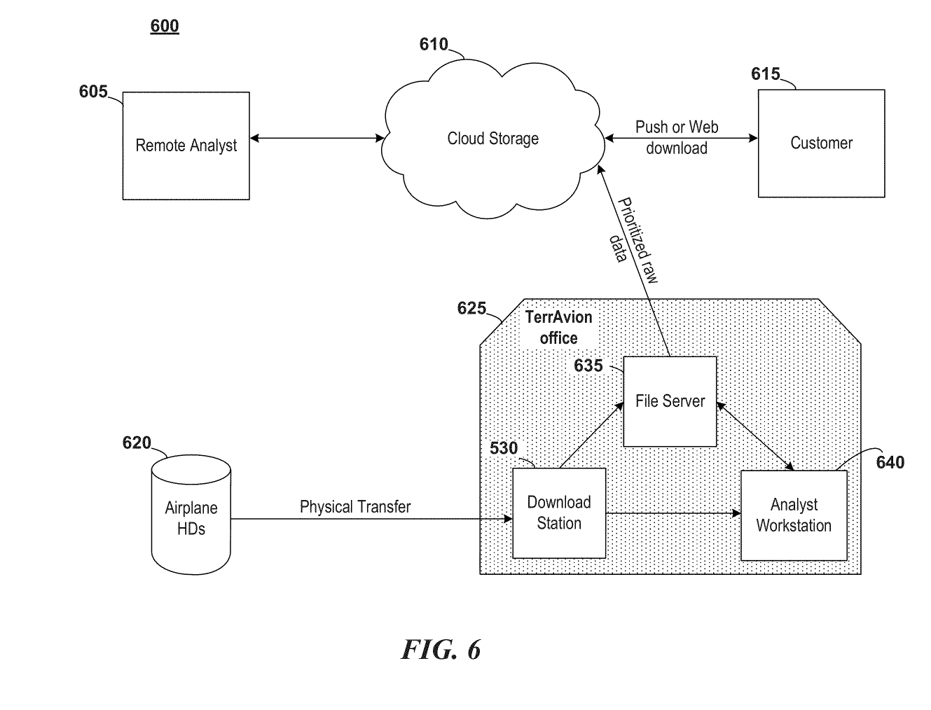

FIG. 6 is a system-block diagram of a cloud-based data analysis system 600 as can be implemented in some embodiments. Data 620 stored on the aerial platform can be transferred over, for example, a physical line, or a network, to a download station with sufficient capacity to store multiple days of flight data 630 at a physical location 625. The data can then be provided to an analyst workstation 640. A local analyst can prepare and review the data at workstation 640. The raw data and/or post-analysis results can then be stored on file server 635. This data, for example, prioritized raw data, can then be provided to a cloud storage 610, possibly for prioritized processing by a remote analyst 605 or automatic processing in the cloud (for example, a third party assessor of vegetation). The results and/or raw data can be accessed by a customer 615 across the web.

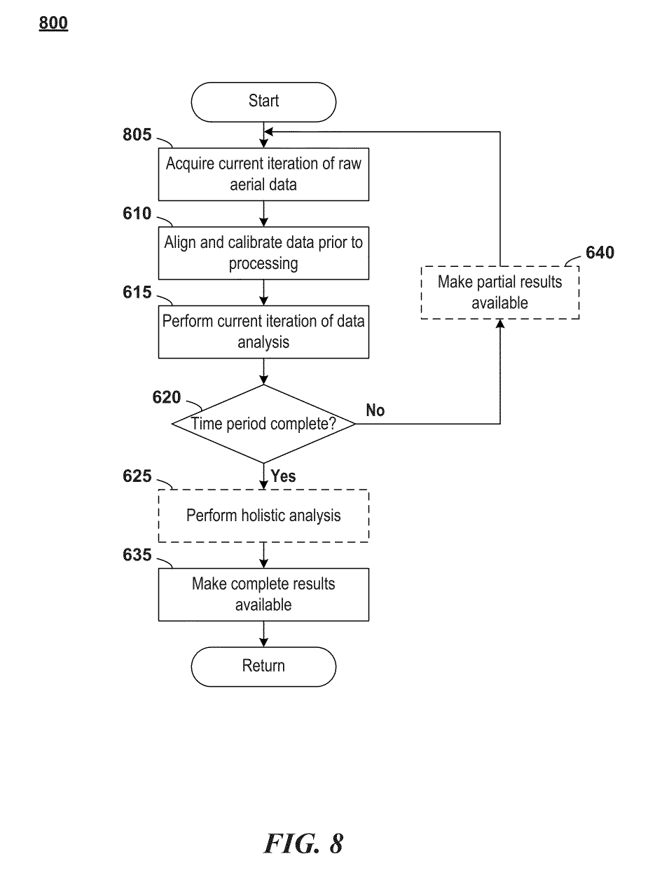

FIG. 8 is a flow diagram depicting a processing pipeline 800 as can be implemented in some embodiments. At block 805 the system can acquire a current iteration of raw imaging data (which can include corresponding inertial and/or location metadata) from the aerial platform for an existing order. At block 810 the system can align and calibrate the raw data (for example, by finding correspondences with previously acquired raw data). At block 815 the system can perform a current iteration of the data analysis, for example, performing an optical flow from a preceding raw data set to a current data set's vegetation pattern and storing the results. At block 820 the system can determine whether the time period, or the number of data acquisitions specified by the customer, are complete. If not, the system can make the partial results available to the customer at block 840 before awaiting the next round of results. If the complete dataset has been acquired, then at block 825 the system can perform a holistic analysis of the dataset (for example, identifying global rather than local trends). At block 835 the system can make the results of the holistic analysis available.

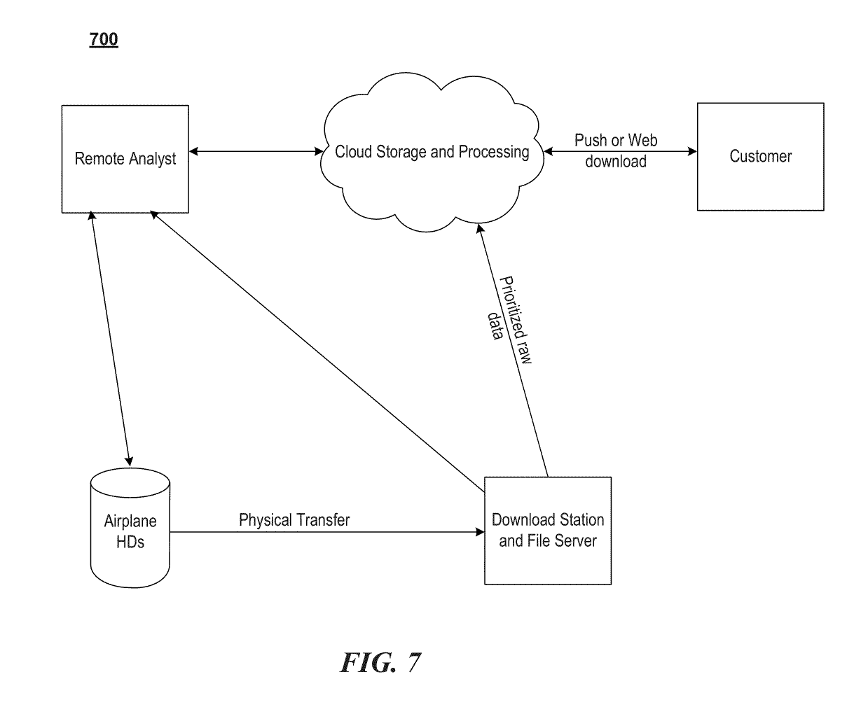

FIG. 7 is a generalized variation 700 of the system presented in FIG. 6 as can be implemented in some embodiments.

Modular interfaces can be used in some embodiments for aerial data interchange at every stage, or many stages, of the process. The image pipeline can be made visible to customer in some embodiments and can be dynamically generated on a server when requested. Some embodiments provide methods to determine which data to archive to store in the long term (for example, using Amazon Glacier®). In some embodiments, data which has not been sold can be placed into long term storage faster than other data. Some embodiments estimate acreage value to forecast potential income of an area. Lower performing acres can be archived first, rather than being immediately made available.

Some embodiments can use one interpreter to verify what another is doing. This can be a way to audit the integrity of the third party reviewers. For example, if one third party reviewer provides an assessment of data, that same data can then be provided to another reviewer and that reviewer's results corroborated with the first reviewer's conclusions. Such integrity checking can be particularly useful in a crowd-sourced system, such as Mechanical Turk®.

### Rerouting and Piloting Algorithms

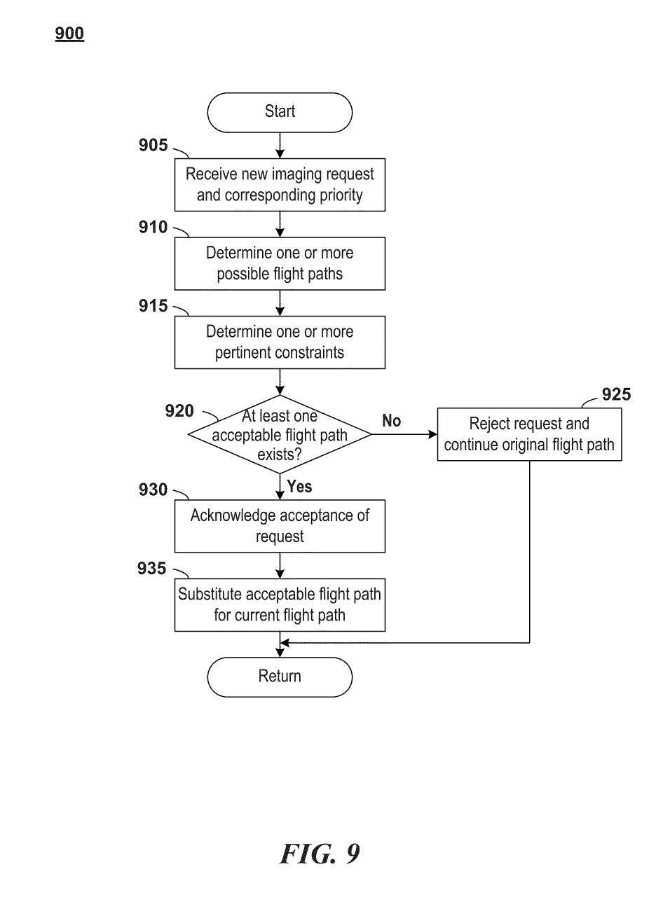

FIG. 9 is a flow diagram depicting a rerouting algorithm 900 as can be implemented in some embodiments. At block 905, the system on board the aerial platform can receive a new imaging request. For example, the pilot can receive a pager update, an aerial drone can receive a wireless data transfer, etc. In some embodiments, the imaging request can include a priority, indicating how the request compares to other requests in a total or partial order. In some embodiments, customers can be provided with an interface depicting the current location of the aerial platform and can be allowed to submit requests. Though in this example the viability of the request is assessed on the platform, in some embodiments viability is determined on a ground-based machine prior to submitting the request to the aerial platform.

At block 910, the system can determine one or more suitable flight paths. At block 915, the system can determine one or more pertinent constraints (for example, remaining daylight hours, available fuel, priority of existing orders, etc.). If, in view of the constraints, no suitable alternative flight path is found at block 920, the system can reject the request at block 925 and continue with the original flight path. If a suitable alternative flight path is found, at bock 930 the system can acknowledge acceptance of the request. At block 935 the system can substitute the acceptable flight path for the current flight path and begin overflight of the new path.

Some embodiments include using weather trends and forecasts to provide automated price quoting. Such quotes can change, for example, in cloudy areas, and are taken into account when redirecting flight paths. Some embodiments, include an automated cloud classification system for automated aircraft retargeting at the macro and/or micro levels. For example, a collection system on the aerial platform can consider satellite imagery and images captured and determine where to go based upon this information.

Some embodiments include a method for automatically generating flight paths that handle the bi-directional reflectance problem by flying at the sun on every flight line, using, for example, time and altitude, while still travelling over all the requested points and polygons. Some embodiments automatically rotate sensors, for example, to maintain cardinal direction orientation of resulting data.

### Customer Interface

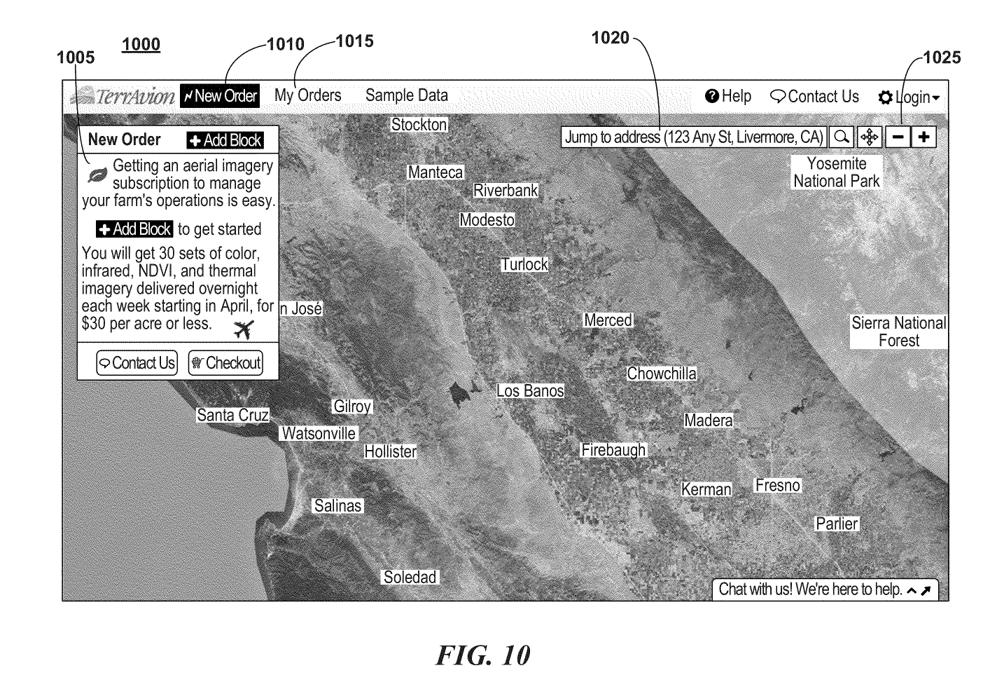

FIG. 10 is a screenshot of a selection system 1000 for specifying customer orders as can be implemented in some embodiments. Particularly, a customer/user can locate a desired location for analysis in a browser using, for example, a map application such as Google Maps®. The user can then click a variety of points to define a polygon (or expand a rectangle, circle, etc.). The user can be charged based upon the location, the area of the polygon, etc. Regions outside the polygon may not be updated with each overflight data acquisition or storage.

In this system screenshot 1000, a region of northern California is depicted. The user can identify a region of interest by zooming into a region of the map (for example, by scrolling a mouse wheel) or selecting icons 1025. The user can also enter an address in box 1020, and the map automatically centered and/or zoomed to that address. By selecting a “New Order” icon 1010, the system can present a new order popup 1005. The popup 1005 can invite the user to create an order block with the “Add Block” icon. Doing so will allow the user to generate an order viewable in the “My Orders” selection.

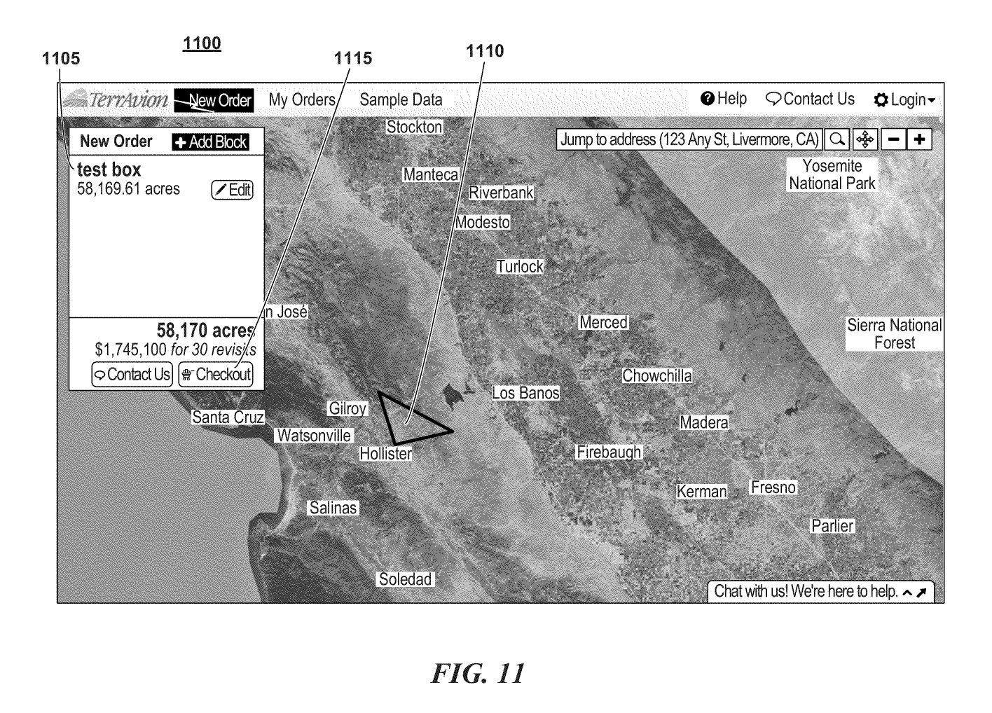

FIG. 11 is a screenshot 1100 of a selection system for specifying customer orders following creation of an order block 1110 as can be implemented in some embodiments. Successful creation of the order block 1110 can automatically result in a price and area-based update of the popup 1105. In this example, the selected order block comprises 58,170 acres and will cost approximately $1,745,100 to map. This is a rather large area and the user can edit the order by adjusting the dimensions of the order polygon, by adjusting the number of requested flights, the data to acquire etc. In some embodiments, the system can overlay the flight path of an aerial platform as well as the platform's current or future position. The user can then be informed whether adjustments to his/her order block will influence the pricing (for example, if a considerable redirect of the aerial platform now or in the future is required, a lower price may be available by delaying or adjusting the request).

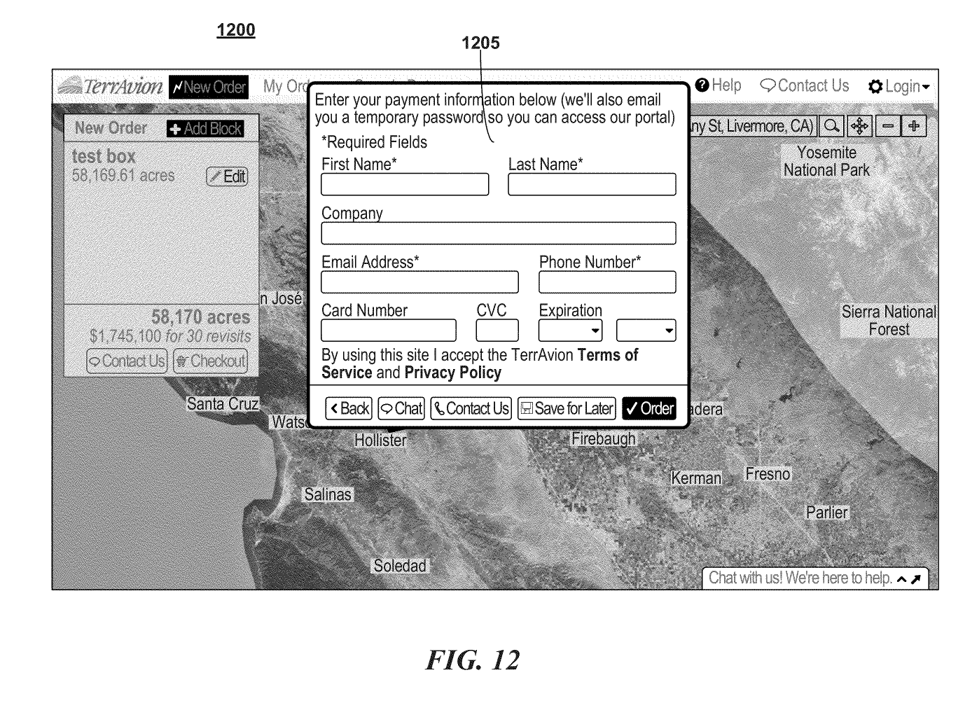

FIG. 12 is a screenshot 1200 of a checkout display for an order block as can be implemented in some embodiments following, for example, selection of checkout icon 1115. A popup 1205 can be presented to the user for input of their payment information. The user can pay for a single order specified by an order block or for all the order blocks.

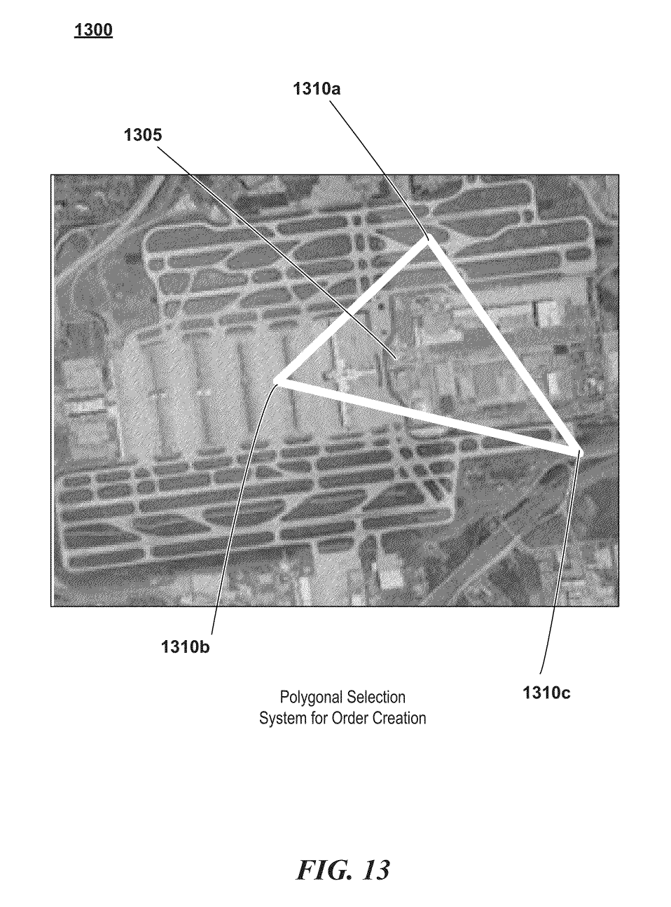

FIG. 13 is a screenshot of a map region with a polygonal order block 1305 specified as can be implemented in some embodiments. The user can indicate a plurality of points 1310a-c to define the contours of the order block. Though an n-point polygon is depicted in this example, circles, rectangles, and other predefined shapes can also be used for order specification.

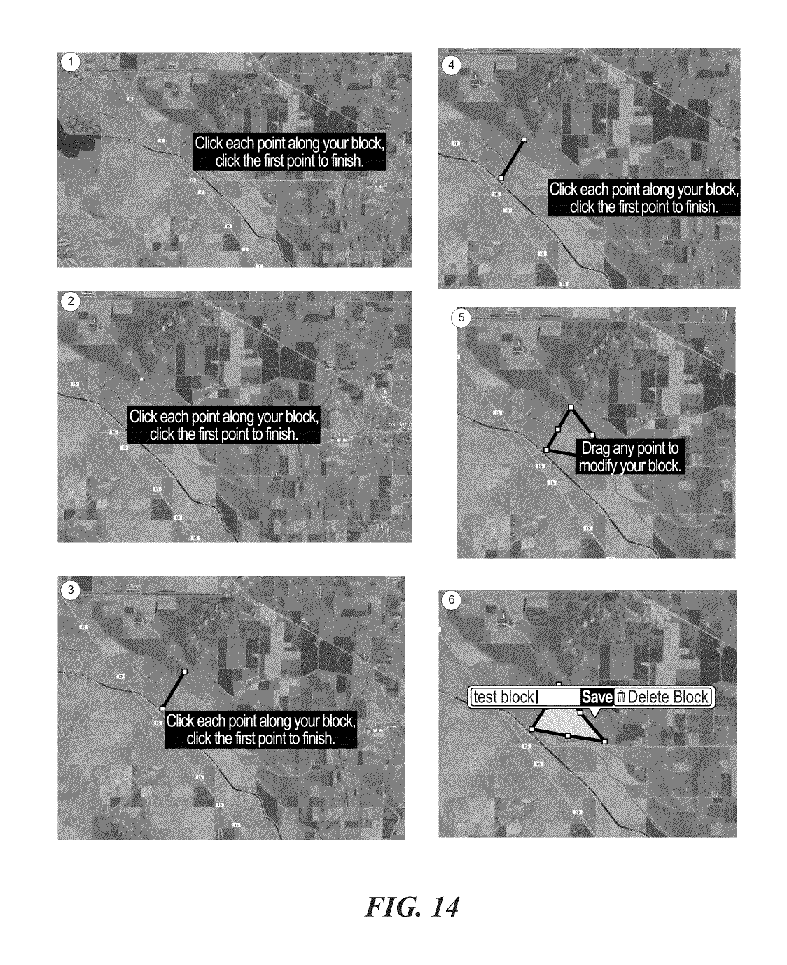

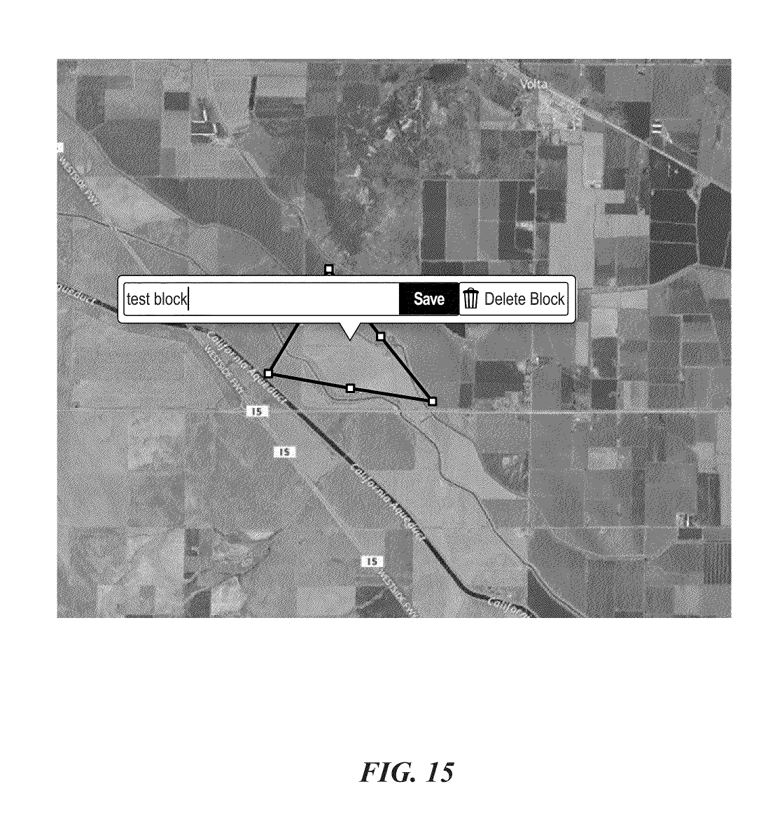

FIG. 14 shows a plurality of screenshots depicting an order block creation as can be implemented in some embodiments. At step 1, the user can select a first point on the map. At step 2, following the first point selection, the system can depict, via a dotted line or other indicator, the resulting edge that would be created were the user to again select another position on the map. At step 3, the user selects a second position. At step 4, the user again moves the cursor to another point and a dotted line indicates the potentially resultant edge. At step 5, a third point is selected. The system can then fill in the resulting triangular region to provide the user with an indication of the order block area. The user can continue to create additional polygonal points, or, as depicted in Step 6, the user can select the initially generated point to complete the order block. A confirmatory popup can be presented allowing the user to name the order block for future reference, or to delete the order block. In this example the order block is named “test block”. FIG. 15 is an enlarged view of the order block of FIG. 14.

### Time Lapsed Regions

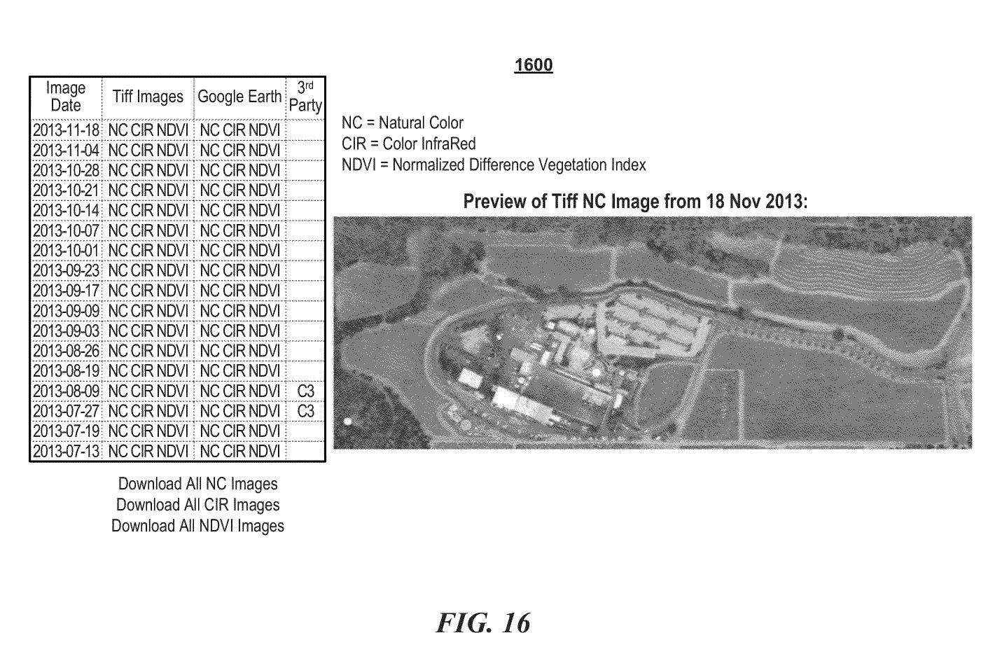

FIG. 16 is a screenshot 1600 of data collected for an ongoing order as can be presented to a user in some embodiments. As depicted, natural color, color infrared, and normalized difference vegetation index image sets can be provided. Other indices and imagery options can be provided as well (for example, thermal variations, reflectance indices, etc.).

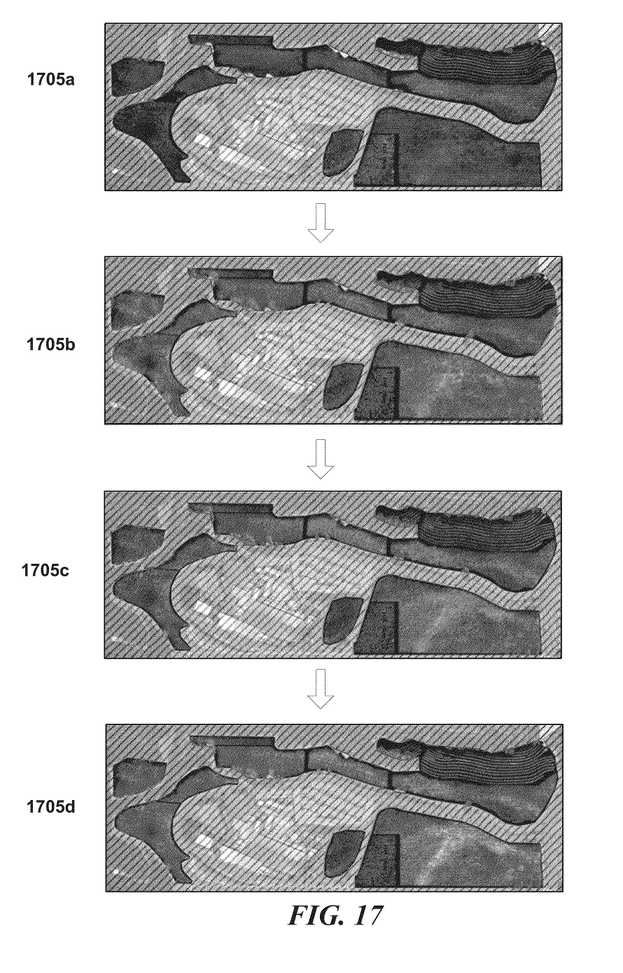

FIG. 17 is a series of time-lapse images 1705a-d of data gathered from a field as can be implemented in some embodiments. For example, the images 1705a-d can be generated by selecting NDVI images from screenshot 1600. Images 1705a and 1705b may have been taken by successive overflights and the intervals between images 1705a-1705d can be approximately the same (daily, weekly, etc.). Interpolations between images can be performed to generate intermediate images where overflight data is unavailable, or a more granular assessment desirable. As depicted, regions in the lower right have increased vegetation over time. This example consists of several order blocks. Regions outside the order blocks (for example, the central building structure and access road) are not updated with each image. Rather, the raw visual color image of these portions can be retained.

### Order and Delivery Interface Variation

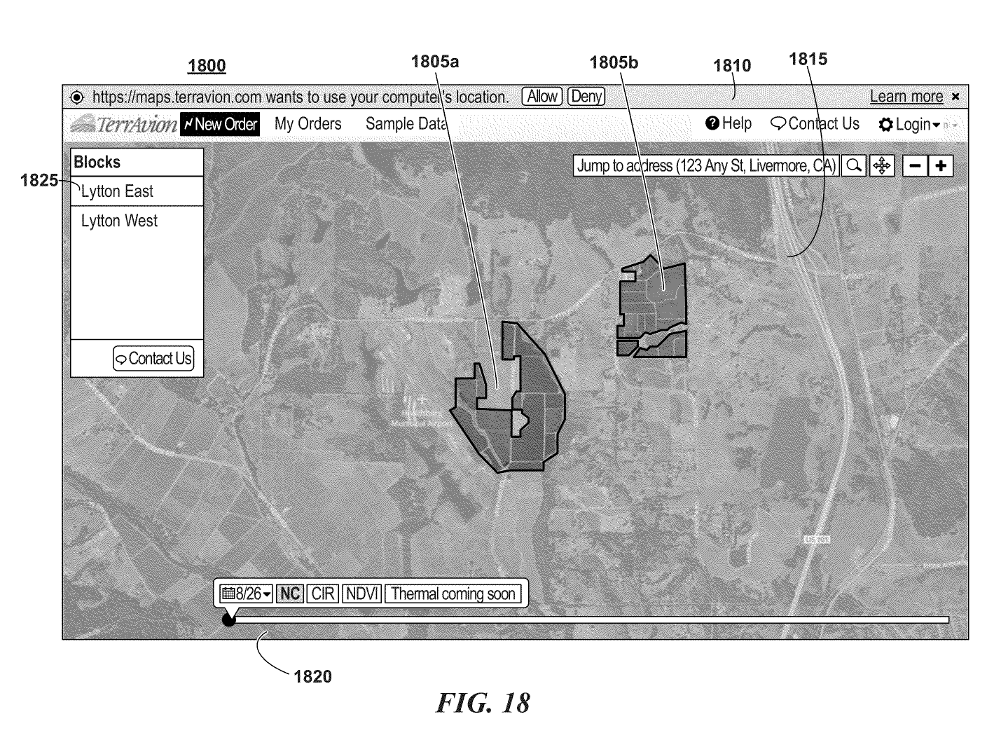

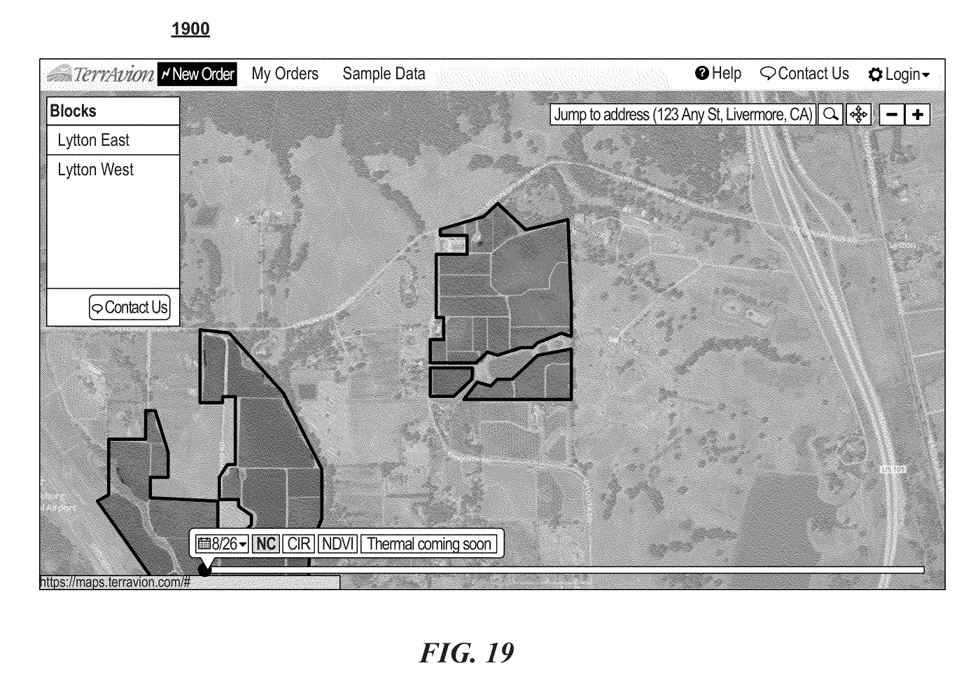

FIG. 18 is a screenshot of an example regional selection interface to review an order as can be implemented in some embodiments. Two regions, Lytton West 1805a and Lytton East 1805b have been created, for example, using order blocks. The interface can be browser based and may assist the user in monitoring relevant locations by collecting the user's present location 1810, for example, using the Internet Protocol address associated with the user. While the regions 1805a-b can be presented in color, the area 1815 outside these regions can be greyed out. A timeline 1820 can be used to select imaging data as well as to select the date of the imaging data. By selecting the “Lytton East” block 1825, the system can zoom into the region enlarged in FIG. 19. FIG. 19 is a screenshot of the example regional selection interface of FIG. 18 following block selection as can be implemented in some embodiments (for example, with the region enlarged). In some embodiments, only privileged users can be able to access prestored block order datasets. For example, a “privileged user” may be one with security access authorized to the system by a parent company of the user. In some embodiments, the users can exchange or share privileges to allow access to different data and operations. For example, as discussed herein, in some embodiments a user can track an aerial platform's progress in the browser display and provide realtime order redirections. Such an operation can be privileged to only certain users (based on experience, fees, etc.) in some embodiments. In some embodiments, the user can be able to delegate such functionality to another user.

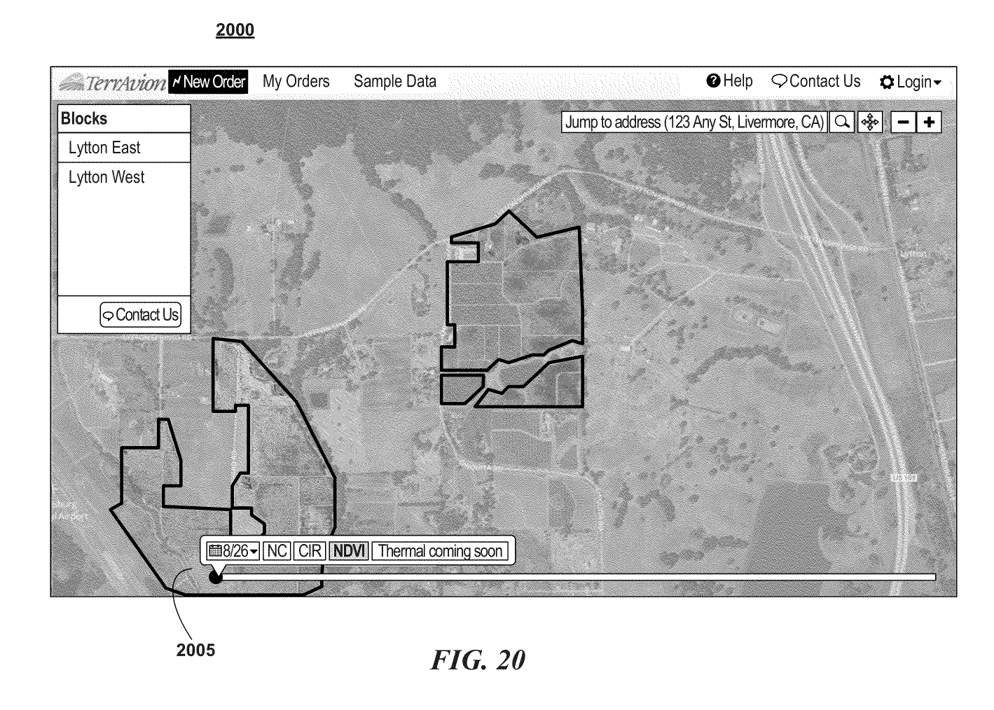

FIG. 20 is a screenshot of the example regional selection interface of FIG. 19 with the Normalized Difference Vegetation Index (NDVI) data for the 8/26 dataset as can be implemented in some embodiments. The user can select this dataset by clicking the appropriate button on the timeline legend 2005. The relevant calendar date can be indicated on the leftmost region of the legend 2005.

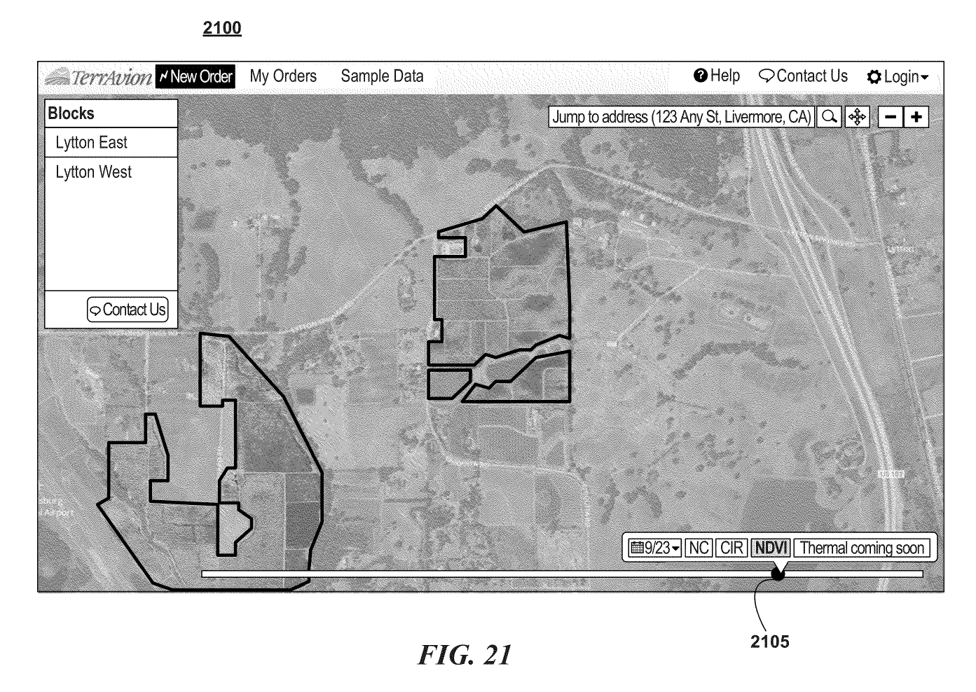

FIG. 21 is a screenshot of the example regional selection interface of FIG. 19 with NDVI viewing for the 9/23 dataset as can be implemented in some embodiments. By sliding the legend to the position 2105 the visualization can be automatically updated. In some embodiments, the display image can be supplemented with satellite imagery (for example, in regions outside the order block) to provide context to the viewer.

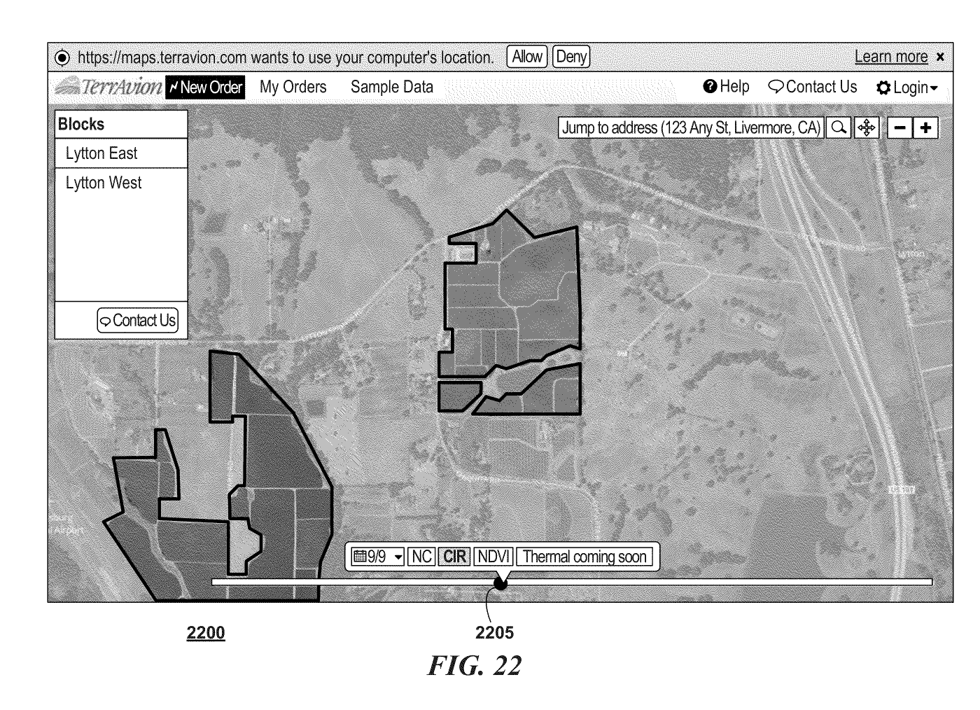

FIG. 22 is a screenshot of the example regional selection interface of FIG. 19 with CIR viewing for the 9/9 dataset as can be implemented in some embodiments. In this example, the timeline legend has been slid to the position 2205 and the computed radiography (CR) dataset presented for viewing.

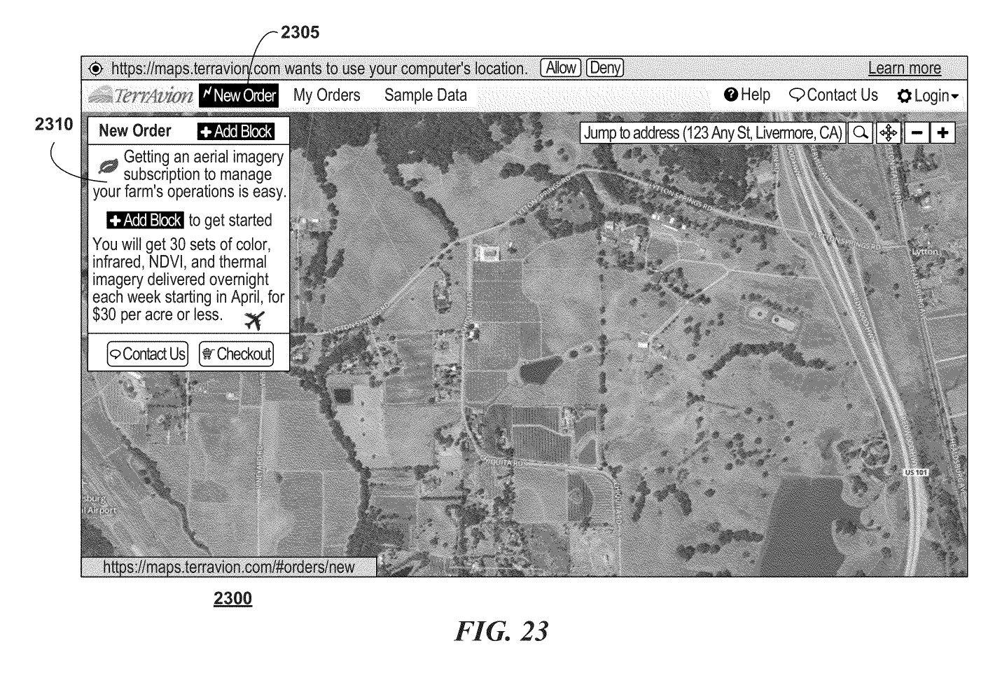

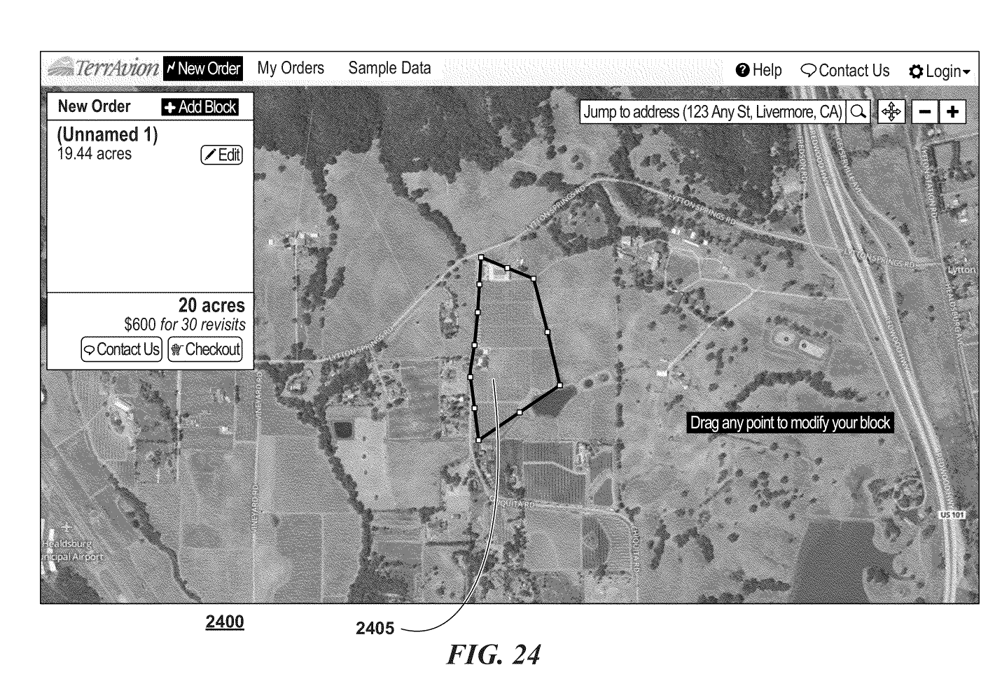

FIG. 23 is a screenshot of the example regional selection interface of FIG. 19 with order block selection activated as can be implemented in some embodiments. Selection of the “New Order” icon 2305 in FIG. 19 can result in the system transitioning to a full color image of the entire region and presentation of a New Order overlay 2310 as previously described. For example, FIG. 24 is a screenshot of the example regional selection interface of FIG. 23 with an order block created using a polygon 2405 as can be implemented in some embodiments. In this example, the polygon 2405 covers approximately 20 acres with an approximate cost of $600 for 30 overflights.

### EMBODIMENT VARIATIONS

Some embodiments provide data acquisition and processing tracking/notification via the browser interface (for example, real-time monitoring of the aerial platform's location, similar to a FedEx® tracking system). In some embodiments, users can be charged extra for certain regions not to be included in overflight datasets (for example, private commercial property) or to be notified if data is sold to third parties. In some embodiments, a customer can specify a window of opportunity and what guarantees concerning the quality of the data they desire (prices can be adjusted in the browser interface accordingly). This information can be used to reserve capacity for “emergency” jobs. Lower priority jobs can be delayed for emergency jobs.

In some embodiments, crowdsourcing can be used to identify appropriate calibration targets or other polygons (for example, consistently colored roof tops, etc.). Amazon Mechanical Turk® and other crowdsourcing systems can be used for calibration and analysis of overflight data.

In some embodiments, the user interface comprises a “Pizza menu” of “toppings” for the customer's imagery. For example, the user can select which features along the processing tool chain they would like applied to their data, depending upon their level of sophistication and budget. Alternatively, various calibration/correction steps can be performed by the customer. Interpreters and third-party analysts can also use this interface to select from this imagery what they need to implement their process on their end.

Some embodiments contemplate a system for purchasing aerial imagery over the Internet without human intervention. For example, an automated description for the user and a price quote can be provided. Automated image capture flagging/rejection can also be performed, such that the system checks that images were collected under appropriate conditions (heading, altitude, sun angle, etc.) and potentially to re-route the flight path to re-collect, if necessary. In some embodiments, these operations are performed for the imagery itself: for example, checking for clouds, shadows, or any image problems.

As discussed above, on-board processing of data can be performed in some embodiments. Satellites, quad-rotors, and other aerial platforms can be used. Where necessary the aerial platform can transmit data to another, for example, ground-based system for storage or processing.

### Application Programming Interface

Some embodiments contemplate providing an application interface to software engineers to that they can make requests to and employ the retrieval system from their own code. A sandbox for interpreters within a cloud based system can be provided. The sandbox can include a virtual machine that software clients can remote desktop into which has access to all the data to which they are entitled. The API can allow customers to automate the manner in which they access data.

### Unmanned Systems

Some embodiments contemplate performing one or more of the features discussed herein where the aerial platform is an unmanned aerial vehicle (UAV). When the UAV has completed its tasks it can fold into a shipping container and alert a transport service to pick it up. This approach can allow non-round trip missions, for example, a plane at higher altitude can drop quad rotor UAVs which perform an overflight and arrive at the customer's location following data collection.

### Computer System

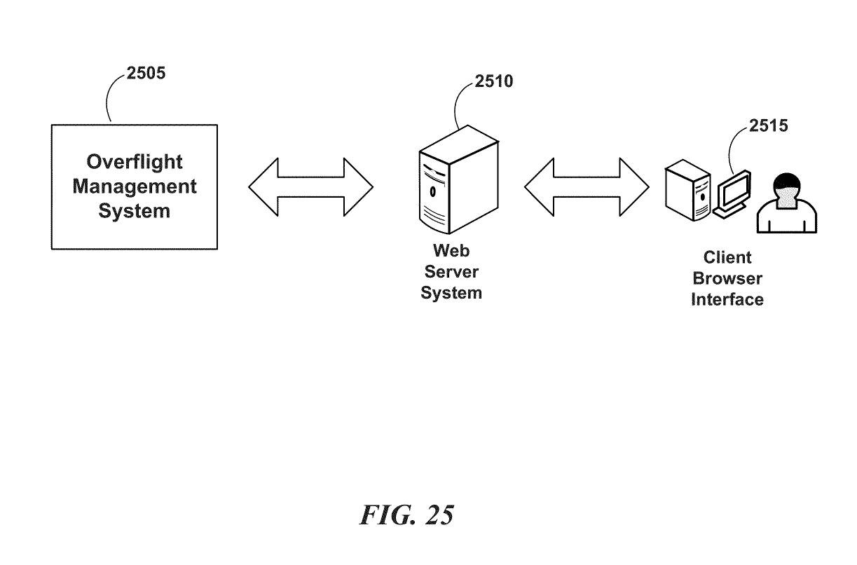

FIG. 25 is a an example system topology applicable to various of the user interface embodiments. As illustrated a web server system 2510 may provide and receive information to a client browser 2515 across, for example, the Internet (for example, using AJAX, independent HTML GET and POST requests, etc.). Though a client web browser 2515 is depicted in this example, the client may also interact via an application program running on a desktop or smartphone device designed specifically to accomplish the described user interface operations. The web server system 2510 can also interact with (and in some embodiments may be incorporated into and the same as) overflight system 2505, for example, to retrieve captured datasets and/or to place orders (the overflight system 2505 may itself have separate databases for these purposes).

Thus, the disclosed embodiments provide more efficient systems and methods for selecting regions for analysis, scheduling and paying for aerial data collection, and then reviewing the results. Such an integrated approach provides economic efficiencies impractical with separately devoted systems. Using various of the disclosed embodiments, a single user can manage disparate analysis projects from a centralized interface.

### Computer System

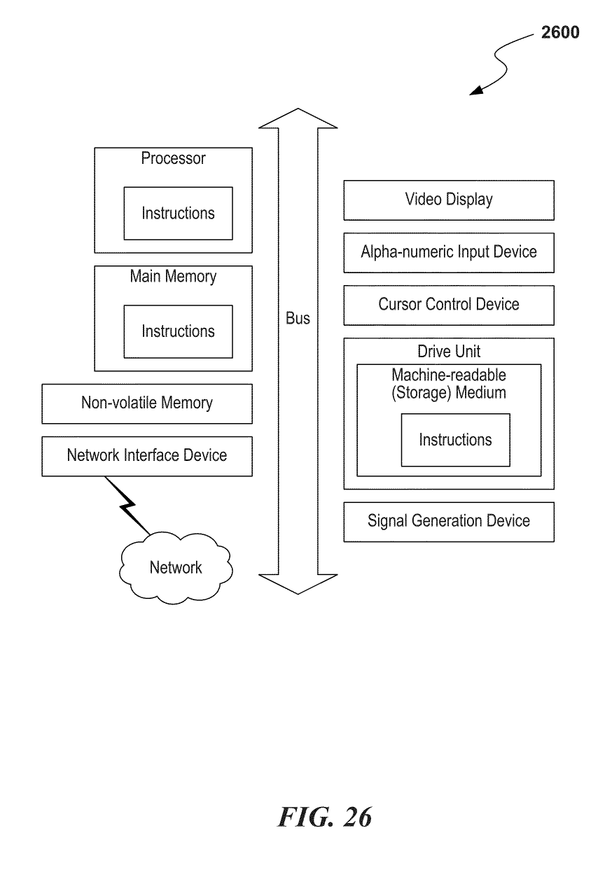

FIG. 26 shows a diagrammatic representation of a machine 2600 in the example form of a computer system within which a set of instructions, for causing the machine to perform any one or more of the methodologies discussed herein, may be executed.

In alternative embodiments, the machine operates as a standalone device or may be connected (for example, networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (for example, a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (for example, Compact Disk Read-Only Memory (CD ROMS), Digital Versatile Disks, (DVDs), etc.), among others, and transmission type media such as digital and analog communication links.

The network interface device enables the machine 2600 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### REMARKS

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms (any claims intended to be treated under 35 U.S.C. §112, ¶6 will begin with the words “means for”). Accordingly, the applicant reserves the right to add additional claims after filing the application to pursue such additional claim forms for other aspects of the disclosure.

What is claimed is:

1. A computer-implemented method comprising:
displaying, using the computer, a map of a portion of a geographic region;
receiving, using the computer, a polygon selection by a user for a portion of the geographic region represented by the map;
determining, using the computer, a cost to perform an overflight order based on an area of the polygon and the location of the geographic region;
presenting the cost, using the computer, to the user; and
causing, using the computer, an overflight order to be generated based at least in part upon the polygon.

2. The computer-implemented method of claim 1, wherein receiving a polygon selection comprises receiving a series of point selections on the map from the user and determining a polygon having vertices corresponding to the point selections.

3. The computer-implemented method of claim 1, wherein determining a cost based on an area of the polygon and the location of the geographic region comprises forwarding the polygon to a remote server with a request for a cost calculation, and receiving a cost of an overflight order associated with the polygon from the remote server.

4. The computer-implemented method of claim 1, the method further comprising:
receiving, using the computer, a previous overflight data selection from the user; and
displaying, using the computer, a portion of the map corresponding to the previous overflight data in color and the remainder of the map in grayscale, wherein the color portion reflects values of the previous overflight data.

5. The computer-implemented method of claim 4, wherein the color of the portion of the map corresponding to the previous overflight data corresponds to at least one of normal color (NC), color infrared (CIR), or normalized difference vegetation index (NDVI) data.

6. The computer-implemented method of claim 4, wherein the previous overflight data corresponds to data collected on a date specified by the user using a timeline slider overlaid on the map, the timeline slider also permitting the user to select between at least one of normal color (NC), color infrared (CIR), or normalized difference vegetation index (NDVI) data for overflight data collected on a given date.

7. The computer-implemented method of claim 1, further comprising:
receiving, using the computer, a plurality of polygon selections from the user; and
displaying, using the computer, a summary of the plurality of polygon selections and a cumulative cost for overflights corresponding to the polygon selections, in an overlay atop the map.

8. The computer-implemented method of claim 1, wherein causing an overflight order to be generated causes sending a request to a remote server.

9. A computer system configured to:
display a map of a portion of a geographic region;
receive a polygon selection by a user for a portion of the geographic region represented by the map;
determine a cost to perform an overflight order based on an area of the polygon and the location of the geographic region;
present the cost to the user; and
cause an overflight order to be generated based at least in part upon the polygon.

10. The computer system of claim 9, wherein receiving a polygon selection comprises receiving a series of point selections on the map from the user and determining a polygon having vertices corresponding to the point selections.

11. The computer system of claim 9, wherein determining a cost based on an area of the polygon and the location of the geographic region comprises forwarding the polygon to a remote server with a request for a cost calculation, and receiving a cost of an overflight order associated with the polygon from the remote server.

12. The computer system of claim 9, the computer system further configured to:
receive a previous overflight data selection from the user; and
display a portion of the map corresponding to the previous overflight data in color and the remainder of the map in grayscale, wherein the color portion reflects values of the previous overflight data.

13. The computer system of claim 12, wherein the color of the portion of the map corresponding to the previous overflight data corresponds to at least one of normal color (NC), color infrared (CIR), or normalized difference vegetation index (NDVI) data.

14. The computer system of claim 12, wherein the previous overflight data corresponds to data collected on a date specified by the user using a timeline slider overlaid on the map, the timeline slider also permitting the user to select between at least one of normal color (NC), color infrared (CIR), or normalized difference vegetation index (NDVI) data for overflight data collected on a given date.

15. The computer system of claim 9, the computer system further configured to:
receive a plurality of polygon selections from the user; and
display a summary of the plurality of polygon selections and a cumulative cost for overflights corresponding to the polygon selections, in an overlay atop the map.

16. The computer system of claim 9, wherein causing an overflight order to be generated causes sending a request to a remote server.

17. A computer interface comprising:
a map of a portion of a geographic region, the map in grayscale except for a portion corresponding to first overflight data captured on a first date;
an address input overlay atop the map, the address input overlay configured to receive a street address and to reorient the map relative to the street address;
a block overlay atop the map, the block overlay configured to display a summary of the plurality of polygon selections corresponding to portions of the geographic region; and
a time slider overlay atop the map, the time slider overlay configured to cause the portion corresponding to first overflight data captured on a first date to be replaced with second overflight data captured on a second date when the second date is selected.

18. The computer interface of claim 17, wherein the first overflight data comprises one of normal color (NC), color infrared (CIR), or normalized difference vegetation index (NDVI) data captured on the first date.

19. The computer interface of claim 17, further comprising:
a polygon overlay atop the map, the polygon overlay illustrating a plurality of points on the map selected by a user for performing an overflight data capture.

20. The computer interface of claim 18, further comprising:
a naming overlay atop the polygon overlay configured to receive an alphanumeric identifier for the polygon overlay.
